(19) United States
(12) Patent Application Publication
(10) Pub. No.: US 2026/0342712 A1
(43) Pub. Date: Oct. 29, 2026

(54) DATA TRANSMISSION CONTROL METHOD AND APPARATUS, DEVICE, AND MEDIUM

(71) Applicant: TENCENT TECHNOLOGY (SHENZHEN) COMPANY LIMITED, Shenzhen (CN)

(72) Inventor: Qiang XIE, Shenzhen (CN)

(21) Appl. No.: 19/702,635

(22) Filed: Jun. 9, 2026

Related U.S. Application Data
(63) Continuation of application No. PCT/CN2025/088931, filed on Apr. 15, 2025.

(30) Foreign Application Priority Data
Apr. 30, 2024 (CN) 202410539006.X

(51) Int. Cl. H04L 45/12

(52) U.S. Cl. CPC H04L 45/123

(57) ABSTRACT

A data transmission control method includes: obtaining a network quality indicator value of a first link in a process of transmitting service data through the first link; in response to determining, based on the network quality indicator value corresponding to the first link, that network quality of the first link is lower than a first preset quality threshold, selecting a target transmission policy from candidate transmission policies based on the network quality indicator value of the first link and a network quality indicator value of a second link, the candidate transmission policies including a policy of transmission through the second link and a policy of transmission through both the second link and first link; and switching from the first link to a target network link corresponding to the target transmission policy and transmitting the service data through the target network link.

### CROSS-REFERENCES TO RELATED APPLICATIONS

This application is a continuation of PCT Application No. PCT/CN2025/088931, filed on Apr. 15, 2025, which claims priority to Chinese Patent Application No. 202410539006.X, entitled "DATA TRANSMISSION CONTROL METHOD AND APPARATUS, DEVICE, AND MEDIUM" filed with the China National Intellectual Property Administration on Apr. 30, 2024, the entire contents of all of which are incorporated herein by reference.

### FIELD OF THE TECHNOLOGY

The present disclosure relates to the field of communication technologies, and specifically to a data transmission control method, a data transmission control apparatus, an electronic device, and a computer-readable medium.

### BACKGROUND OF THE DISCLOSURE

With continuous development of computer technologies, application of data transmission in many fields constantly expands and deepens. The data transmission may be applied to various scenarios such as education, entertainment, and office. For example, in an entertainment scenario, a terminal device may transmit entertainment-related data to a server, to complete an entertainment-related service. During data transmission, network quality may change, and the change of the network quality affects data transmission efficiency.

### SUMMARY

Embodiments of the present disclosure provide a data transmission control method and apparatus, a device, and a medium, so that reliability of controlling data transmission is high, and data transmission efficiency is improved.

The embodiments of the present disclosure provide a data transmission control method, the method being performed by a terminal device, the terminal device having established a first link and a second link with a server respectively through a first-type network and a second-type network, and the method including: obtaining a network quality indicator value corresponding to the first link in a process of transmitting service data through the first link; in response to determining, based on the network quality indicator value corresponding to the first link, that network quality of the first link is lower than a first preset quality threshold, selecting, from candidate transmission policies based on the network quality indicator value corresponding to the first link and a network quality indicator value corresponding to the second link, a target transmission policy configured to transmit the service data, the candidate transmission policies including a policy of transmission through the second link, and a policy of transmission through both the second link and the first link; and switching from the first link to a target network link corresponding to the target transmission policy and transmitting the service data through the target network link.

The embodiments of the present disclosure provide an electronic device, including: at least one processor; and a memory, configured to store at least one program, the electronic device, when the at least one program is executed by the at least one processor, being caused to implement the foregoing data transmission control method.

The embodiments of the present disclosure provide a non-transitory computer-readable medium, having a computer program stored therein, the computer program, when being executed by a processor, implements the foregoing data transmission control method.

The foregoing general descriptions and the following detailed descriptions are merely for exemplary and explanatory purposes, and cannot limit the present disclosure.

### BRIEF DESCRIPTION OF THE DRAWINGS

FIG. 1 is a schematic diagram of an exemplary implementation environment to which a technical solution of an embodiment of the present disclosure may be applied.

FIG. 2 is a flowchart of a data transmission control method according to an exemplary embodiment of the present disclosure.

FIG. 3 is a flowchart of a data transmission control method according to another exemplary embodiment of the present disclosure.

FIG. 4 is a flowchart of another data transmission control method according to another exemplary embodiment of the present disclosure.

FIG. 5 is a flowchart of another data transmission control method according to another exemplary embodiment of the present disclosure.

FIG. 6 is a flowchart of another data transmission control method according to another exemplary embodiment of the present disclosure.

FIG. 7 is a schematic diagram of a transmission indication information according to an exemplary embodiment of the present disclosure.

FIG. 8 is a schematic diagram of an exemplary implementation environment to which a technical solution of an embodiment of the present disclosure may be applied.

FIG. 9 is a schematic diagram of a data transmission control method according to another exemplary embodiment of the present disclosure.

FIG. 10 is a flowchart of a data transmission control method according to another exemplary embodiment of the present disclosure.

FIG. 11 is a schematic diagram of threshold corresponding to a network quality indicator of a wireless fidelity network link according to an exemplary embodiment of the present disclosure.

FIG. 12 is a schematic diagram of threshold corresponding to a network quality indicator of a 4G cellular network link according to another exemplary embodiment of the present disclosure.

FIG. 13 is a threshold schematic diagram of a 5G cellular network link according to another exemplary embodiment of the present disclosure.

FIG. 14 is a block diagram of a data transmission control apparatus according to an exemplary embodiment of the present disclosure.

FIG. 15 is a schematic structural diagram of a computer system adapted to implement an electronic device according to an embodiment of the present disclosure.

### DESCRIPTION OF EMBODIMENTS

Exemplary embodiments are described in detail herein, and examples of the exemplary embodiments are shown in the accompanying drawings. When the following descriptions are made with reference to the accompanying drawings, unless otherwise indicated, the same numbers in different accompanying drawings represent the same or similar elements. The implementations described in the following exemplary embodiments do not represent all implementations identical to the present disclosure. On the contrary, the implementations are merely examples of apparatuses and methods that are described in detail in the appended claims and that are identical to some embodiments of the present disclosure.

In the embodiments of the present disclosure, a term "module" or "unit" refers to a computer program having a predetermined function or a part of a computer program, and works together with another related part to achieve a predetermined objective, and may be all or partially implemented through software, hardware (such as a processing circuit or a memory), or a combination thereof. Similarly, one processor (or a plurality of processors or memories) may be configured to implement at least one module or unit. In addition, each module or unit may be a part of an overall module or unit including a function of the module or unit.

The block diagram shown in the accompanying drawings is merely a functional entity and does not necessarily correspond to a physically independent entity. In other words, such functional entities may be implemented in the form of software, or implemented in at least one hardware module or integrated circuit, or implemented in different networks and/or processor apparatuses and/or microcontroller apparatuses.

The flowcharts shown in the accompanying drawings are merely an example for descriptions, do not necessarily include all content and operations/steps, and are not necessarily performed in the described orders. For example, some operations/steps may be further divided, while some operations/steps may be combined or partially combined. Therefore, an actual execution order may vary according to an actual case.

"A plurality of" mentioned in the present disclosure refers to two or more. "And/Or" describes an association relationship for describing associated objects and indicates that three relationships may exist. For example, A and/or B may represent the following three cases: Only A exists, both A and B exist, and only B exists. The character "/" generally indicates an "or" relationship between the associated objects.

With continuous development of computer technologies, application of data transmission in a large quantity of fields constantly expands and deepens. The data transmission may be applied to various scenarios such as education, entertainment, and office. For example, in an entertainment scenario, a terminal device may transmit entertainment-related data to a server, to complete an entertainment-related service. However, during data transmission, network quality may change, affecting data transmission efficiency.

Therefore, how to reliably control the data transmission to improve the data transmission efficiency is a problem that needs to be resolved urgently.

To reliably control the data transmission to improve the data transmission efficiency, the present disclosure provides a data transmission control solution. Referring to FIG. 1, FIG. 1 is a schematic diagram of an implementation environment according to an embodiment of the present disclosure. The implementation environment mainly includes a service party 101, a transmission control party 102, and a data transmission party 103.

The service party 101 is a party initiating a service request, and generally corresponds to a user.

The transmission control party 102 is a party receiving the service request, and generally corresponds to a terminal device. For example, the terminal device includes, but is not limited to, a smartphone, a computer (a tablet computer, a notebook computer, a desktop computer, or the like), a smart household device (a television, a refrigerator, an air conditioner, a washing machine, a robot vacuum, or the like), a smart wearable device (a bracelet or a watch), and the like.

The transmission control party 102 may be located in a plurality of types of networks at the same time. The plurality of types of networks include, but are not limited to, a wireless fidelity network (WIFI), a cellular network, a Bluetooth network, a satellite network, and the like.

The data transmission party 103 is a party that performs service data interaction with the transmission control party 102, and generally corresponds to a server. Exemplarily, the server may be an independent physical server, or may be a server cluster or a distributed system formed by a plurality of physical servers, the server cluster or the distributed system including a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The data transmission party 103 establishes a communication connection to the transmission control party 102 through the foregoing network. Specifically, the data transmission party 103 establishes a first link with the transmission control party 102 through a first-type network, and establishes a second link with the transmission control party 102 through a second-type network.

In some embodiments of the present disclosure, the data transmission control method may be jointly performed by the service party 101, the transmission control party 102, and the data transmission party 103. To be specific:
the service party 101 transmits a service request to the transmission control party 102.

Correspondingly, the transmission control party 102 receives the service request transmitted by the service party 101, and transmits service data corresponding to the service request with the data transmission party 103 through the first link (to be specific, the transmission control party 102 may transmit the service data to the data transmission party 103 through the first link, or the transmission control party 102 may receive the service data transmitted by the data transmission party 103 through the first link).

In a process of transmitting the service data between the transmission control party 102 and the data transmission party 103 through the first link, the transmission control party 102 may obtain a network quality indicator value corresponding to the first link, and in response to determining, based on the network quality indicator value corresponding to the first link, that network quality of the first link is lower than a first preset quality threshold, select, from candidate transmission policies based on the network quality indicator value corresponding to the first link and a network quality indicator value corresponding to the second link, a target transmission policy configured to transmit the service data, the candidate transmission policies including transmission through the second link and transmission through both the second link and the first link.

Then, the transmission control party 102 continues to transmit the service data with the data transmission party 103 based on a target network link corresponding to the target transmission policy (to be specific, the transmission control party 102 may transmit the service data to the data transmission party 103 through the target network link, or the transmission control party 102 may receive the service data transmitted by the data transmission party 103 through the target link).

The first-type network and the second-type network are different types of networks. In some embodiments, the first-type network may be a wireless fidelity network, and the second-type network may be a cellular network. In some other embodiments, the first-type network may be a cellular network, and the second-type network may be a wireless fidelity network.

In some other embodiments of the present disclosure, the data transmission control method may be performed by any one or two of the service party 101, the transmission control party 102, and the data transmission party 103. A specific execution process is similar to the execution process in the foregoing embodiment, and details are not described herein again.

Quantities of service parties 101, transmission control parties 102, and data transmission parties 103 in FIG. 1 are merely exemplary. Based on an actual requirement, any quantity of service parties 101, any quantity of transmission control parties 102, and any quantity of data transmission parties 103 may exist.

The technical solution of the embodiment shown in FIG. 1 may be applied to various scenarios, including but not limited to intelligent traffic, assisted driving, a cloud technology, artificial intelligence, and the like. In actual application, corresponding adjustment may be performed according to a specific application scenario.

Exemplarily, if the technical solution of the embodiment shown in FIG. 1 is applied to an intelligent traffic scenario or an assisted driving scenario, the service party 101 may be a driver, the transmission control party 102 may be an in-vehicle terminal, a navigation terminal, or the like, and the data transmission party 103 may be a computer or the like. For example, the in-vehicle terminal may transmit driving service data corresponding to a driving service request with the computer through the first link, and in a process in which the in-vehicle terminal and the computer transmit the driving service data through the first link, the in-vehicle terminal may obtain the network quality indicator corresponding to the first link, and in response to determining, based on the network quality indicator value corresponding to the first link, that the network quality of the first link is lower than the first preset quality threshold, the target transmission policy configured to transmit the service data is selected from the candidate transmission policies based on the network quality indicator value corresponding to the first link and the network quality indicator value corresponding to the second link, the candidate transmission policies including the transmission through the second link and the transmission through both the second link and the first link. Then, the in-vehicle terminal continues to transmit the driving service data to the computer based on the target network link corresponding to the target transmission policy.

Exemplarily, if the technical solution of the embodiment shown in FIG. 1 is applied to a cloud technology scenario or an artificial intelligence scenario, the service party 101 may be a game user, the transmission control party 102 may be a smartphone, a computer, or the like, and the data transmission party 103 may be a cloud server, or the like. For example, the smartphone may transmit game service data corresponding to a game service request with the cloud server through the first link, and in a process in which the smartphone and the cloud server transmit the game service data through the first link, the smartphone may obtain the network quality indicator value corresponding to the first link, and in response to determining that the network quality of the first link is lower than the first preset quality threshold based on the network quality indicator value corresponding to the first link, the target transmission policy configured to transmit the service data is selected from the candidate transmission policies based on the network quality indicator value corresponding to the first link and the network quality indicator value corresponding to the second link, the candidate transmission policies including the transmission through the second link and the transmission through both the second link and the first link. Then, the smartphone continues to transmit the game service data to the cloud server based on the target network link corresponding to the target transmission policy.

In a specific implementation of the present disclosure, data related to a user is involved. When the embodiments of the present disclosure are applied to a specific product or technology, user permission or consent needs to be obtained, and collection, use, and processing of the related data need to comply with related laws and regulations and standards of related countries and regions.

Implementation details of the technical solution of the embodiment of the present disclosure are described in detail below.

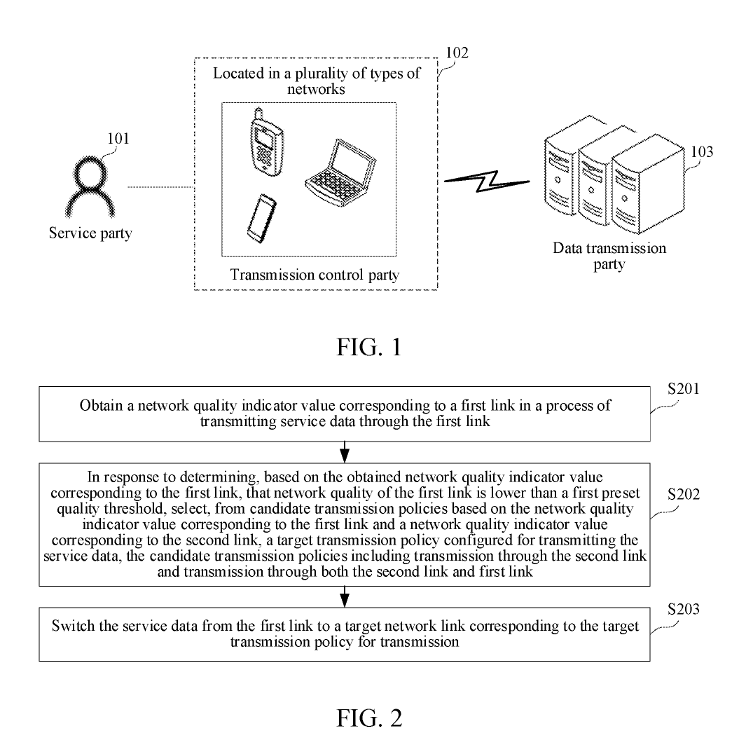

Referring to FIG. 2, FIG. 2 is a flowchart of a data transmission control method according to some embodiments of the present disclosure. The data transmission control method may be performed by a transmission control party 102, and the transmission control party 102 may be a terminal device. As shown in FIG. 2, the data transmission control method at least includes S201 to S203, which are described in detail below.

S201: Obtain a network quality indicator value corresponding to a first link in a process of transmitting service data through the first link.

In the embodiments of the present disclosure, the first link refers to a communication link corresponding to a first-type network, a transmission control party establishing the first link with a data transmission party (the data transmission party may be a server) through the first-type network; and the second link is a communication link corresponding to a second-type network, the transmission control party establishing the second link with the data transmission party through the second-type network. The first-type network and the second-type network are different types of networks, and correspondingly, the first link and the second link are different types of communication links.

In some embodiments of the present disclosure, the first-type network may be a wireless fidelity network, and the second-type network may be a cellular network, or the first-type network may be a cellular network, and the second-type network may be a wireless fidelity network. For ease of understanding, in this embodiment of the present disclosure, an example in which the first-type network is a wireless fidelity network and the second-type network is a cellular network is used for description. In actual application, the first-type network and the second-type network may be flexibly adjusted according to a specific application scenario.

In this embodiment of the present disclosure, the network quality indicator corresponding to the first link is an indicator that can reflect a quality of an environment of the first link. This embodiment of the present disclosure further relates to a network quality indicator corresponding to the second link. Similarly, the network quality indicator corresponding to the second link is an indicator that can reflect a quality of an environment of the second link.

Exemplarily, when the first-type network is a wireless fidelity network, the network quality indicator corresponding to the first link includes, but is not limited to, a received signal strength indicator (RSSI), a signal-to-noise ratio (SNR), channel utilization, signal attenuation, a packet loss rate, jitter, and the like.

Exemplarily, when the second-type network is a cellular network, for example, a 4th generation (4G) mobile communication technology, the network quality indicator corresponding to the second link includes, but is not limited to, reference signal receiving power (RSRP), a reference signal receiving quality (RSRQ), a signal-to-interference plus noise ratio (SINR), the RSSI, a network latency, connection stability, and the like. Alternatively, the second-type network is a cellular network, for example, when a 5th generation (5G) mobile communication technology is used, the network quality indicator corresponding to the second link includes, but is not limited to, a synchronization signal reference signal received power (SS-RSRP), a synchronization signal reference signal received quality (SS-RSRQ), a synchronization signal signal-to-interference plus noise ratio (SS-SINR), a data rate, a connection density, and the like.

In actual application, the network quality indicator corresponding to the first link and the network quality indicator corresponding to the second link may be flexibly adjusted based on a specific application scenario.

In this embodiment of the present disclosure, in the process of transmitting the service data through the first link, the transmission control party may obtain the network quality indicator value corresponding to the first link. In other words, in the process of transmitting the service data through the first link, the transmission control party obtains the network quality indicator value corresponding to the first link in real time, to detect a network quality status of the first link in real time.

For example, assuming that the first link is configured as a wireless fidelity network link, in a process of transmitting the service data between the transmission control party and the data transmission party through the wireless fidelity network link, the transmission control party may obtain a network quality indicator value corresponding to the wireless fidelity network link, for example, the RSSI.

S202: In response to determining, based on the network quality indicator value corresponding to the first link, that network quality of the first link is lower than a first preset quality threshold, select, from candidate transmission policies based on the network quality indicator value corresponding to the first link and a network quality indicator value corresponding to the second link, a target transmission policy configured to transmit the service data, the candidate transmission policies including transmission through the second link and transmission through both the second link and first link.

In this embodiment of the present disclosure, the transmission control party obtains the network quality indicator value corresponding to the first link, and may determine the network quality status of the first link according to the network quality indicator value corresponding to the first link.

In some embodiments of the present disclosure, a process of determining the network quality status of the first link according to the network quality indicator value corresponding to the first link may include:
detecting a magnitude relationship between the network quality indicator value corresponding to the first link and a first preset threshold, to obtain a first detection result; and
in response to the first detection result indicating that the network quality indicator value corresponding to the first link is greater than the first preset threshold, determining that the network quality of the first link is higher than the first preset quality threshold; and
in response to the first detection result indicating that the network quality indicator value corresponding to the first link is less than or equal to the first preset threshold, determining that the network quality of the first link is lower than the first preset quality threshold.

In other words, in some embodiments, the transmission control party compares the network quality indicator value corresponding to the first link with the first preset threshold corresponding to the network quality indicator, and obtains the first detection result based on a comparison case.

In some embodiments of the present disclosure, the process of determining the network quality status of the first link according to the network quality indicator value corresponding to the first link may further include:
detecting a magnitude relationship between the network quality indicator value corresponding to the first link and a second preset threshold, to obtain a second detection result; and
in response to the second detection result indicating that the network quality indicator value corresponding to the first link is greater than the second preset threshold, determining that the network quality of the first link is higher than a second preset quality threshold; and
in response to the second detection result indicating that the network quality indicator value corresponding to the first link is less than or equal to the second preset threshold, determining that the network quality of the first link is lower than the second preset quality threshold.

In other words, in some embodiments, the transmission control party compares the network quality indicator value corresponding to the first link with the second preset threshold corresponding to the network quality indicator, to obtain the first detection result based on a comparison case.

For example, following the foregoing example, assuming that RSSI2 represents an obtained RSSI value, and RSSI0 and RSSI1 are respectively configured for representing a first preset threshold and a second preset threshold (which are usually preset) corresponding to the RSSI. If RSSI2>RSSI0, it is determined that network quality of a wireless fidelity network link is higher than the first preset quality threshold (that is, the network quality of the wireless fidelity network link is superior); if RSSI1<RSSI2≤RSSI0, it is determined that the network quality of the wireless fidelity network link is lower than the first preset quality threshold and the network quality of the wireless fidelity network link is higher than the second preset quality threshold (that is, the network quality of the wireless fidelity network link is medium); or if RSSI2≤RSSI1, it is determined that the network quality of the wireless fidelity network link is lower than the second preset quality threshold (that is, the network quality of the wireless fidelity network link is poorer).

In some embodiments, the transmission control party may continuously obtain a plurality of values of the same network quality indicator, calculate an average of the plurality of values, and then compare the average with the first preset threshold and the second preset threshold corresponding to the network quality indicator, to obtain the first detection result and the second detection result.

In this way, accuracy of the first detection result and the second detection result obtained by continuously obtaining the plurality of values of the same network quality indicator and by using a magnitude relationship between the average and the first preset threshold and a magnitude relationship between the average and the second preset threshold is high.

In some embodiments, the transmission control party may continuously obtain the plurality of values of the same network quality indicator, and separately compare a smallest value and a largest value in the plurality of values with the first preset threshold and the second preset threshold corresponding to the network quality indicator, to obtain the first detection result and the second detection result.

In this way, the first detection result and the second detection result, obtained by continuously obtaining the plurality of values of the same network quality indicator and based on magnitude relationship between the largest and smallest values and the first preset threshold and the second preset threshold respectively, have relatively high accuracy, and a detection process is simple.

In another embodiment, the transmission control party may obtain at least one value corresponding to each of different network quality indicators, to improve accuracy of obtaining the first detection result and the second detection result. In actual application, a quantity of network quality indicators may be flexibly adjusted according to a specific application scenario.

In this embodiment of the present disclosure, the network quality status of the first link can be simply and accurately detected through the network quality indicator value corresponding to the first link, which is applicable to a plurality of scenarios.

In this embodiment of the present disclosure, the transmission control party determines the network quality status of the first link according to the network quality indicator value corresponding to the first link, and then may determine, through the detected status, the target transmission policy configured to transmit the service data.

In some embodiments of the present disclosure, that the determine, through the detected status, the target transmission policy configured to transmit the service data may include the following two cases.
Case 1: In response to detecting that the network quality of the first link is lower than the first preset quality threshold, the target transmission policy configured to transmit the service data is selected from the candidate transmission policies based on the network quality indicator value of the first link and the network quality indicator value corresponding to the second link.
Case 2: In response to detecting that the network quality of the first link is higher than the first preset quality threshold, the service data remains to be transmitted through the first link.

In other words, in some embodiments, if the network quality of the first link is medium or the network quality of the first link is poor, the transmission control party may select, from the candidate transmission policies through the network quality indicator value of the first link and the network quality indicator value corresponding to the second link, the target transmission policy configured to transmit the service data; or if the network quality of the second link is superior, the transmission control party may keep transmitting the service data through the first link.

In this embodiment of the present disclosure, the transmission control party may obtain the network quality indicator value corresponding to the second link, and determine the network quality status of the second link according to the network quality indicator value corresponding to the second link.

In some embodiments of the present disclosure, a process of determining the network quality status of the second link according to the network quality indicator value corresponding to the second link may include:
detecting a magnitude relationship between the network quality indicator value corresponding to the second link and a third preset threshold, to obtain a third detection result; and
determining that the network quality of the second link is higher than a third preset quality threshold in response to the third detection result indicating that the network quality indicator value corresponding to the second link is greater than the third preset threshold; and
determining that the network quality of the second link is lower than the third preset quality threshold in response to the second detection result indicating that the network quality indicator value corresponding to the second link is less than or equal to the third preset threshold.

In other words, in some embodiments, the transmission control party compares the network quality indicator value corresponding to the second link with the third preset threshold corresponding to the network quality indicator, and obtains the third detection result based on a comparison case.

For example, following the foregoing example, assuming that RSSI2 represents an obtained RSSI value, and RSSIO and RSSI1 are respectively configured for representing a first preset threshold and a second preset threshold (which are usually preset) corresponding to the RSSI. If RSSI2>RSSI0, it is determined that network quality of a wireless fidelity network link is higher than the first preset quality threshold (that is, the network quality of the wireless fidelity network link is superior); if RSSI1<RSSI2<RSSI0 it is determined that the network quality of the wireless fidelity network link is lower than the first preset quality threshold and the network quality of the wireless fidelity network link is higher than the second preset quality threshold (that is, the network quality of the wireless fidelity network link is medium); or if RSSI2≤RSSI1, it is determined that the network quality of the wireless fidelity network link is lower than the second preset quality threshold (that is, the network quality of the wireless fidelity network link is poorer).

In some embodiments, the transmission control party may continuously obtain a plurality of values of the same network quality indicator, calculate an average of the plurality of values, and then compare the average with the third preset threshold corresponding to the network quality indicator, to obtain the third detection result.

In this way, accuracy of the third detection result obtained by continuously obtaining the plurality of values of the same network quality indicator and by using a magnitude relationship between the average and the third preset threshold is high.

In some embodiments, the transmission control party may continuously obtain the plurality of values of the same network quality indicator, and compare a smallest value and a largest value in the plurality of values with the third preset threshold corresponding to the network quality indicator, to obtain the third detection result.

In this way, the third detection result, obtained by continuously obtaining the plurality of values of the same network quality indicator and based on the magnitude relationship between the largest and smallest values and the third preset threshold, has relatively high accuracy, and a detection process is simple.

In another embodiment, the transmission control party may alternatively obtain at least one value corresponding to the same network quality indicator, to improve efficiency of obtaining the third detection result. In actual application, a quantity of network quality indicators may be flexibly adjusted according to a specific application scenario.

In this embodiment of the present disclosure, the network quality status of the second link can be simply and accurately detected through the network quality indicator value corresponding to the second link, which is applicable to a plurality of scenarios.

In this embodiment of the present disclosure, the transmission control party determines the network quality status of the first link according to the network quality indicator value corresponding to the first link, and then may determine, through the detected status, the target transmission policy configured to transmit the service data.

In some embodiments of the present disclosure, that the determine, through the detected status, the target transmission policy configured to transmit the service data may include the following two cases.
Case 1: In response to detecting that the network quality of the first link is lower than the first preset quality threshold, the target transmission policy configured to transmit the service data is selected from the candidate transmission policies based on the network quality indicator value of the first link and the network quality indicator value corresponding to the second link.
Case 2: In response to detecting that the network quality of the first link is higher than the first preset quality threshold, the service data remains to be transmitted through the first link.

In other words, in some embodiments, if the network quality of the first link is medium or the network quality of the first link is poor, the transmission control party may select, from the candidate transmission policies through the network quality indicator value of the first link and the network quality indicator value corresponding to the second link, the target transmission policy configured to transmit the service data; or if the network quality of the second link is superior, the transmission control party may keep transmitting the service data through the first link.

In this embodiment of the present disclosure, the transmission control party may obtain the network quality indicator value corresponding to the second link, and determine the network quality status of the second link according to the network quality indicator value corresponding to the second link.

In some embodiments of the present disclosure, a process of determining the network quality status of the second link according to the network quality indicator value corresponding to the second link may include:
detecting a magnitude relationship between the network quality indicator value corresponding to the second link and a third preset threshold, to obtain a third detection result; and
determining that the network quality of the second link is higher than a third preset quality threshold in response to the third detection result indicating that the network quality indicator value corresponding to the second link is greater than the third preset threshold; and
determining that the network quality of the second link is lower than the third preset quality threshold in response to the second detection result indicating that the network quality indicator value corresponding to the second link is less than or equal to the third preset threshold.

In other words, in some embodiments, the transmission control party compares the network quality indicator value corresponding to the second link with the third preset threshold corresponding to the network quality indicator, and obtains the third detection result based on a comparison case.

For example, following the foregoing example, assuming that the second link is a 4G cellular network link.

An obtained network quality indicator corresponding to the 4G cellular network link is the RSRP and the RSRQ. An RSRP1 is configured for representing an obtained value of the RSRP, an RSRPO is configured for representing a third preset threshold (which is generally obtained through presetting) corresponding to the RSRP, an RSRQ1 is configured for representing an obtained value of the RSRQ, and an RSRQ0 is configured for representing a third preset threshold (which is generally obtained through presetting) corresponding to the RSRQ. If RSRP1>RSRP0 and RSRQ1>RSRQ0, it is determined that the network quality of the 4G cellular network link is higher than the third preset quality threshold (that is, network quality of the 4G cellular network link is superior). If RSRP1<RSRP0 and/or RSRQ1≤RSRQ0, it is determined that the network quality of the 4G cellular network link is lower than the third preset quality threshold (that is, the network quality of the 4G cellular network link is not superior, and may be medium or poor, and the network quality indicator value corresponding to the second link may be further distinguished from a fourth preset threshold corresponding to the network quality indicator).

For another example, the second link is configured as a 5G cellular network link. An obtained network quality indicator corresponding to the 5G cellular network link is the SS- RSRP and the SS-SINR. An SS-RSRP1 is configured for representing an obtained value of the SS-RSRP, an SS-RSRP0 is configured for representing a third preset threshold (which is generally obtained through presetting) corresponding to the SS-RSRP, an SS-SINR1 is configured for representing an obtained value of the SS-SINR, and an SS-SINRO is configured for representing a third preset threshold (which is generally obtained through presetting) corresponding to the SS-SINR. If SS-RSRP1>SS-RSRP0 and SS-SINR1>SS-SINR0, it is determined that the network quality of the 5G cellular network link is higher than the third preset quality threshold (that is, network quality of the 5G cellular network link is superior); and if SS- RSRP1≤SS-RSRP0 and/or SS-SINR1≤SS-SINR0, it is determined that the network quality of the 5G cellular network link is lower than the third preset quality threshold (that is, the network quality of the 5G cellular network link is not superior, and may be medium or poor, and the network quality indicator value corresponding to the second link may be further distinguished from a fourth preset threshold corresponding to the network quality indicator).

In some embodiments, the transmission control party may continuously obtain a plurality of values of the same network quality indicator, calculate an average of the plurality of values, and then compare the average with the third preset threshold corresponding to the network quality indicator, to obtain the third detection result.

In this way, accuracy of the third detection result obtained by continuously obtaining the plurality of values of the same network quality indicator and by using a magnitude relationship between the average and the third preset threshold is high.

In some embodiments, the transmission control party may continuously obtain the plurality of values of the same network quality indicator, and compare a smallest value and a largest value in the plurality of values with the third preset threshold corresponding to the network quality indicator, to obtain the third detection result.

In this way, the third detection result, obtained by continuously obtaining the plurality of values of the same network quality indicator and based on the magnitude relationship between the largest and smallest values and the third preset threshold, has relatively high accuracy, and a detection process is simple.

In another embodiment, the transmission control party may alternatively obtain at least one value corresponding to the same network quality indicator, to improve efficiency of obtaining the third detection result. In actual application, a quantity of network quality indicators may be flexibly adjusted according to a specific application scenario.

In this embodiment of the present disclosure, the network quality status of the second link can be simply and accurately detected through the network quality indicator value corresponding to the second link, which is applicable to a plurality of scenarios.

The candidate transmission policies in this embodiment of the present disclosure includes, but is not limited to, transmission through the second link, transmission through both the second link and the first link, and the like. The transmission through the second link refers to transmitting the service data only by using the second link, and the transmission through both the second link and the first link refers to transmitting the service data by using the second link and the first link at the same time.

The target transmission policy in this embodiment of the present disclosure refers to a transmission policy that is selected from candidate transmission policies through the network quality indicator value corresponding to the first link and the network quality indicator value corresponding to the second link for current service data transmission, when the network quality of the first link is medium or the network quality of the first link is poor. The target transmission policy may be the transmission through the second link, or the transmission through both the second link and the first link.

S203: Switch the service data from the first link to a target network link corresponding to the target transmission policy for transmission.

In this embodiment of the present disclosure, the transmission control party selects the target transmission policy, and then may switch the service data from the first link to the target network link corresponding to the target transmission policy for transmission.

In this embodiment of the present disclosure, in the process of transmitting the service data through the first link, the network quality indicator value corresponding to the first link is obtained, so that real-time detection of the network quality of the first link may be implemented through the network quality indicator value corresponding to the first link, thereby achieving high real-time performance. In addition, when the network quality of the first link is lower than the first preset quality threshold, the target transmission policy configured to transmit the service data is selected from the candidate transmission policies through the network quality indicator value corresponding to the first link and the network quality indicator value corresponding to the second link, and the service data is switched from the first link to the target network link corresponding to the target transmission policy for transmission, thereby implementing switching of the transmission network link corresponding to the service data and high reliability of controlling data transmission, and improving transmission efficiency of the service data.

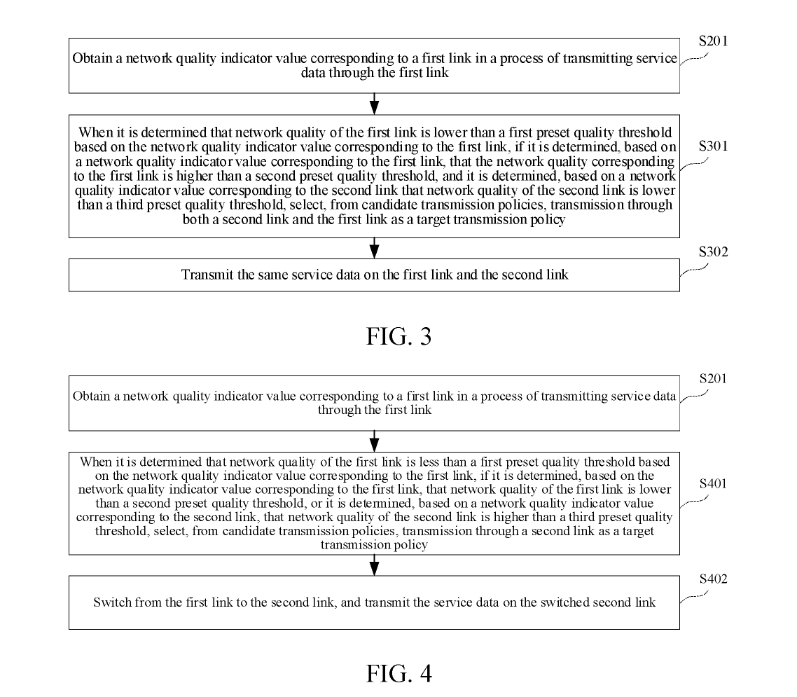

In some embodiments of the present disclosure, another data transmission control method is provided. The data transmission control method may be performed by the transmission control party 102. As shown in FIG. 3, the data transmission control method at least includes S301, S302, and S201.

S301 and S302 are described in detail below.

S301: Select, from candidate transmission policies, transmission through both the second link and the first link as a target transmission policy in response to determining that network quality of a first link is higher than a second preset quality threshold based on a network quality indicator value corresponding to the first link, and it is determined that network quality of the second link is lower than a third preset quality threshold based on a network quality indicator value corresponding to the second link.

As described in the foregoing embodiments, a transmission control party may determine a network quality status of the second link according to the network quality indicator value corresponding to the second link, and then determine the target transmission policy configured to transmit the service data according to a network quality status of the first link and a network quality status of the second link.

In this embodiment of the present disclosure, if the network quality of the first link is higher than the second preset quality threshold and the network quality of the second link is lower than the third preset quality threshold, the transmission controller selects, from the candidate transmission policies, the transmission through both the second link and the first link as the target transmission policy.

For example, following the foregoing example, assuming that it is determined that network quality of a wireless fidelity network link is higher than the second preset threshold (that is, the network quality of the wireless fidelity network link is medium) and network quality of a 4G cellular network link is lower than the third preset quality threshold (that is, the network quality of the 4G cellular network link is not superior), in this case, a transmission policy in which the 4G cellular network link and the wireless fidelity network link are used in the candidate transmission policies is used as the target transmission policy.

For another example, assuming that it is determined that the network quality of the wireless fidelity network link is higher than the second preset threshold (that is, the network quality of the wireless fidelity network link is medium) and network quality of a 5G cellular network link is lower than the third preset quality threshold (that is, the network quality of the 5G cellular network link is not superior), in this case, a joint transmission policy in which the 5G cellular network link and the wireless fidelity network link are used in the candidate transmission policies is used as the target transmission policy.

S302: Transmit the same service data on the first link and the second link.

In this embodiment of the present disclosure, the transmission control party uses the transmission through both the second link and the first link as the target transmission policy, and then transmits the same service data through the first link and the second link.

For example, following the foregoing example, service data of a specified size is represented by M. If the target transmission policy is a joint transmission policy in which the 4G cellular network link and the wireless fidelity network link are used, the service data M is separately transmitted through the 4G cellular network link and the wireless fidelity network link. In other words, the service data M is transmitted on the 4G cellular network link, and simultaneously, the service data M is transmitted on the wireless fidelity network link.

For another example, if the target transmission policy is a joint transmission policy in which the 5G cellular network link and the wireless fidelity network link are used, the service data M is separately transmitted on the 5G cellular network link and the wireless fidelity network link, that is, the service data M is transmitted on the 5G cellular network link, and simultaneously, the service data M is transmitted on the wireless fidelity network link.

For detailed descriptions of S201 shown in FIG. 3, reference may be made to S201 shown in FIG. 2, and details are not described herein again.

In this embodiment of the present disclosure, when the network quality of the first link is medium and the network quality of the second link is medium or poor, the service data is simultaneously transmitted through the first link and the second link (that is, the service data is simultaneously transmitted between the transmission control party and a data transmission party through a double link of the first link and the second link), thereby improving transmission efficiency of the service data, which is applicable to a plurality of scenarios.

In some embodiments of the present disclosure, another data transmission control method is provided. The data transmission control method may be performed by the transmission control party 102. As shown in FIG. 4, the data transmission control method at least includes S401, S402, and S201.

S401 and S402 are described in detail below.

S401: Select, from candidate transmission policies, transmission through a second link as a target transmission policy in response to determining that network quality of a first link is lower than a second preset quality threshold based on a network quality indicator value corresponding to the first link, or it is determined that network quality of the second link is higher than a third preset quality threshold based on a network quality indicator value corresponding to the second link.

As described in the foregoing embodiments, a transmission control party may determine a network quality status of the second link according to the network quality indicator value corresponding to the second link, and then determine the target transmission policy configured to transmit the service data according to a network quality status of the first link and a network quality status of the second link.

In this embodiment of the present disclosure, in response to determining that the network quality of the first link is lower than the second preset quality threshold or the network quality of the second link is higher than the third preset quality threshold, the transmission control party selects, from the candidate transmission policies, transmission through the second link as the target transmission policy.

For example, following the foregoing example, assuming that it is determined that network quality of a wireless fidelity network link is lower than the second preset quality threshold (that is, the network quality of the wireless fidelity network link is poor) or network quality of a 4G cellular network link is higher than the third preset quality threshold (that is, the network quality of the 4G cellular network link is superior), in this case, the transmission policy in which the 4G cellular network link is used in the candidate transmission policies is used as the target transmission policy.

For another example, assuming that it is determined that the network quality of the wireless fidelity network link is lower than the second preset quality threshold (that is, the network quality of the wireless fidelity network link is poor) or network quality of a 5G cellular network link is higher than the preset quality threshold (that is, the network quality of the 5G cellular network link is superior), in this case, a transmission policy in which the 5G cellular network link is used in the candidate transmission policies is used as the target transmission policy.

S402: Switch from the first link to the second link, and transmit the service data on the switched second link.

In this embodiment of the present disclosure, the transmission control party uses the transmission through the second link as the target transmission policy, and then transmits the service data through the second link.

For example, following the foregoing example, service data of a specified size is represented by M. If the target transmission policy is the transmission policy in which the 4G cellular network link is used, the service data M is transmitted through the 4G cellular network link.

For another example, if the target transmission policy is the transmission policy in which the 5G cellular network link is used, the service data M is transmitted through the 5G cellular network link.

For detailed descriptions of S201 shown in FIG. 4, reference may be made to S201 shown in FIG. 2, and details are not described herein again.

In this embodiment of the present disclosure, when the network quality of the first link is poor or the network quality of the second link is superior, the service data is transmitted through the second link (that is, the service data is transmitted between the transmission control party and a data transmission party through the second link), thereby improving transmission efficiency of the service data, which is applicable to a plurality of scenarios.

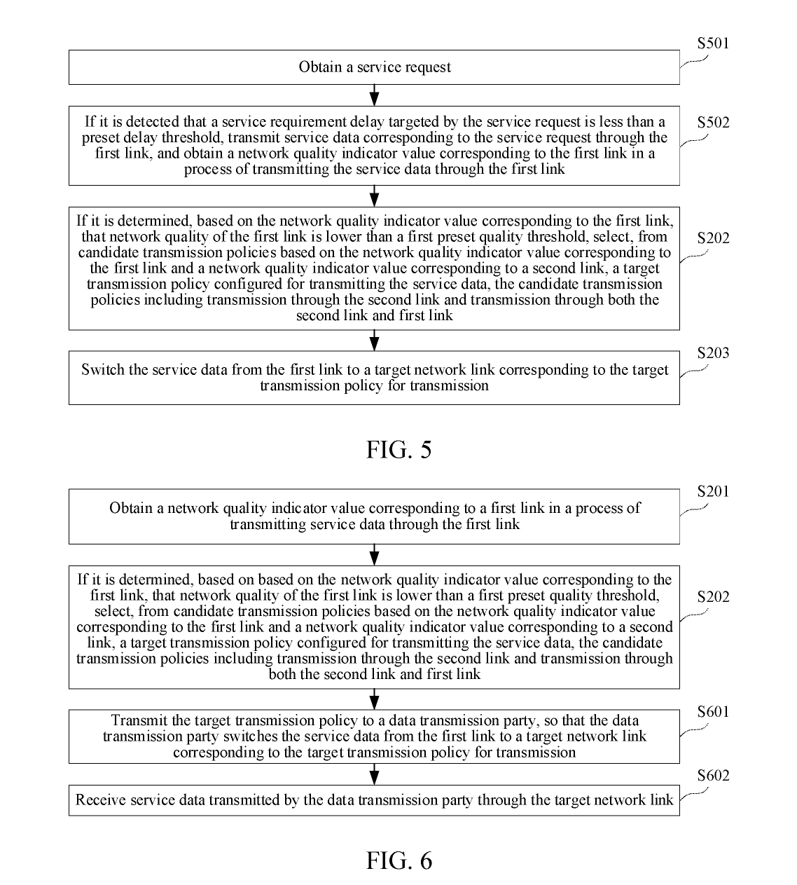

In some embodiments of the present disclosure, another data transmission control method is provided. The data transmission control method may be performed by the transmission control party 102. As shown in FIG. 5, the data transmission control method at least includes S501, S502, S202, and S203.

S501 and S502 are described in detail below.

S501: Obtain a service request triggered by a service party.

In this embodiment of the present disclosure, when the service party has a service requirement, the service party may trigger the service request. Correspondingly, the transmission control party obtains the service request triggered by the service party.

S502: In response to detecting that a service requirement delay targeted by the service request is less than a preset delay threshold, transmit service data corresponding to the service request through the first link, and obtain a network quality indicator value corresponding to the first link in a process of transmitting the service data through the first link.

In this embodiment of the present disclosure, the transmission control party obtains the service request triggered by the service party, and then may detect whether the service requirement delay targeted by the service request is less than the preset delay threshold. If the service requirement delay is less than the preset delay threshold, it represents that the service targeted by the service request is a low-delay-required service, such as a real-time communication service (a voice call service, a video call service, a game service, or the like) or an industrial automation service (a control service of a factory production line, a robot operation service, or the like). If the service requirement delay is greater than the preset delay threshold, it represents that the service targeted by the service request is a high-delay-tolerant service, such as a file transmission and downloading service and an email transmission service.

In this embodiment of the present disclosure in response to detecting that a service requirement delay targeted by the service request is less than a preset delay threshold, the transmission controller transmits the service data corresponding to the service request through the first link, and obtain the network quality indicator value corresponding to the first link in the process of transmitting the service data through the first link. In other words, in this embodiment of the present disclosure, when the service request targets the low-delay-required service, the transmission control party triggers an operation of obtaining the network quality indicator value corresponding to the first link in the process of transmitting the service data through the first link.

For example, assuming that the transmission control party obtains the service request triggered by the service party, and detects that the service requirement delay targeted by the service request is lower than the preset delay threshold. In this case, the service data corresponding to the service request is transmitted through a wireless fidelity network link, and in a process of transmitting the service data through the wireless fidelity network link, a network quality indicator value corresponding to the wireless fidelity network link is obtained.

In some embodiments of the present disclosure, that the detect whether the service requirement delay targeted by the service request is less than the preset delay threshold may include:
obtaining a service type targeted by the service request;
if a service type matching the obtained service type is found from a preset low-delay-required service table, determining that the service requirement delay targeted by the service request is less than the preset delay threshold; and
if the service type matching the obtained service type is not found from the preset low-delay-required service table, determining that the service requirement delay targeted by the service request is greater than a preset delay threshold.

In other words, in some embodiments, the transmission control party presets a preset low-delay-required service table, the preset low-delay-required service table including a service type corresponding to a service whose service requirement delay is less than the preset delay threshold, so that whether the service requirement delay targeted by the service request is less than the preset delay threshold may be detected by querying the preset low-delay-required service table through the service type targeted by the service request.

In this embodiment of the present disclosure, it can be easily and accurately detected whether the service requirement delay targeted by the service request is less than the preset delay threshold, so that strong support is provided for obtaining the network quality indicator value corresponding to the first link.

In some embodiments of the present disclosure, the process of transmitting the service data corresponding to the service request through the first link in S502 may include:
obtaining the network quality indicator value corresponding to the first link; and
transmitting the service data corresponding to the service request through the first link in response to determining that network quality of the first link is higher than the first preset quality threshold based on the obtained network quality indicator value corresponding to the first link.

In other words, in some embodiments, after detecting that the service requirement time delay targeted by the service request is less than the preset delay threshold, the transmission control party may search for the first link, obtain the network quality indicator value corresponding to the first link, then determine a network quality status of the first link through the network quality indicator value corresponding to the first link, and transmit the service data corresponding to the service request through the first link after detecting that the network quality of the first link is greater than the first preset quality threshold.

In some embodiments, before transmitting the service data corresponding to the service request through the first link, the transmission control party determines the network quality status of the first link through the network quality indicator value corresponding to the first link. In response to detecting that the network quality of the first link is higher than the first preset quality threshold, it indicates that the network quality of the first link is superior. Therefore, in this case, the service data corresponding to the service request is transmitted through the first link.

In some embodiments, before transmitting the service data corresponding to the service request through the first link, the transmission control party determines the network quality status of the first link through the network quality indicator value corresponding to the first link, which is similar to that the transmission control party determines the network quality status of the first link based on the network quality indicator value corresponding to the first link in the process of transmitting the service data through the first link in the foregoing embodiments, and so on.

In this embodiment of the present disclosure, when it is detected that the network quality of the first link is superior, the first link having a superior network quality is used to transmit the service data. In other words, when the service data is initially transmitted, the transmission network link is selected rather than any transmission network link. Therefore, transmission efficiency of the service data is further improved.

For detailed descriptions of S202 and S203 shown in FIG. 5, reference may be made to S202 and S203 shown in FIG. 2, and details are not described herein again.

In this embodiment of the present disclosure, a solution of real-time detection is used for the low-delay-required service, which is more adaptive to a requirement of the low-delay-required service and has high flexibility.

In some embodiments of the present disclosure, another data transmission control method is provided. The data transmission control method may be performed by the transmission control party 102. As shown in FIG. 6, the data transmission control method at least includes S601, S602, S201, and S202.

S601 and S602 are described in detail below.

S601: Transmit a target transmission policy to a data transmission party, so that the data transmission party switches service data from a first link to a target network link corresponding to the target transmission policy for transmission.

In this embodiment of the present disclosure, the transmission control party selects the target transmission policy, and then may transmit the target transmission policy to the data transmission party. Correspondingly, the data transmission party receives the target transmission policy transmitted by the transmission control party, and switches the service data from the first link to the target network link corresponding to the target transmission policy for transmission.

In some embodiments of the present disclosure, a process of transmitting the target transmission policy to the data transmission party in S601 may include:
transmitting the same target transmission policy to the data transmission party through a second link and the first link if the target transmission policy is transmission through both the second link and the first link; and

If the target transmission policy is transmission through the second link, the target transmission policy is transmitted to the data transmission party through the second link.

In other words, in some embodiments, if the target transmission policy is the transmission through both the second link and the first link, the transmission control party transmits the same target transmission policy to the data transmission party through the second link and the first link respectively. If the target transmission policy is the transmission through the second link, the transmission control party transmits the target transmission policy to the data transmission party through the second link.

For example, following the foregoing example, assuming that the target transmission policy is a transmission policy in which a 4G cellular network link and a wireless fidelity network link are used, the target transmission policy is separately transmitted through the 4G cellular network link and the wireless fidelity network link, to transmit the target transmission policy to the data transmission party. Alternatively, assuming that the target transmission policy is a transmission policy in which a 5G cellular network link and the wireless fidelity network link are used, the target transmission policy is separately transmitted through the 5G cellular network link and the wireless fidelity network link, to transmit the target transmission policy to the data transmission party.

For another example, assuming that the target transmission policy is a transmission policy in which the 4G cellular network link is used, the target transmission policy is transmitted through the 4G cellular network link, to transmit the target transmission policy to the data transmission party. Alternatively, assuming that the target transmission policy is a transmission policy in which the 5G cellular network link is used, the target transmission policy is transmitted through the 5G cellular network link, to transmit the target transmission policy to the data transmission party.

In this embodiment of the present disclosure, when the target transmission policy is the transmission through both the second link and the first link, the target transmission policy is transmitted to the data transmission party through both the second link and the first link. Transmission of the target transmission policy matches the target transmission policy, so that transmission efficiency of the target transmission policy is improved; and when the target transmission policy is the transmission through the second link, the target transmission policy is transmitted to the data transmission party through the second link. The transmission of the target transmission policy matches the target transmission policy, so that the transmission efficiency of the target transmission policy is improved.

In some embodiments of the present disclosure, a process of transmitting the target transmission policy to the data transmission party in S601 may include:
generating transmission indication information corresponding to the target transmission policy, performing value filling on a specified field in the generated transmission indication information, and transmitting the filled transmission indication information to the data transmission party.

In other words, in some embodiments, the transmission control party generates the transmission indication information corresponding to the target transmission policy, performs value filling on a specified field in the generated transmission indication information, and then transmits the filled transmission indication information to the data transmission party. Correspondingly, the data transmission party receives the filled transmission indication information transmitted by the transmission control party, to switch, based on the filled transmission indication information, the service data from the first link to the target network link corresponding to the target transmission policy in the filled transmission indication information for transmission.

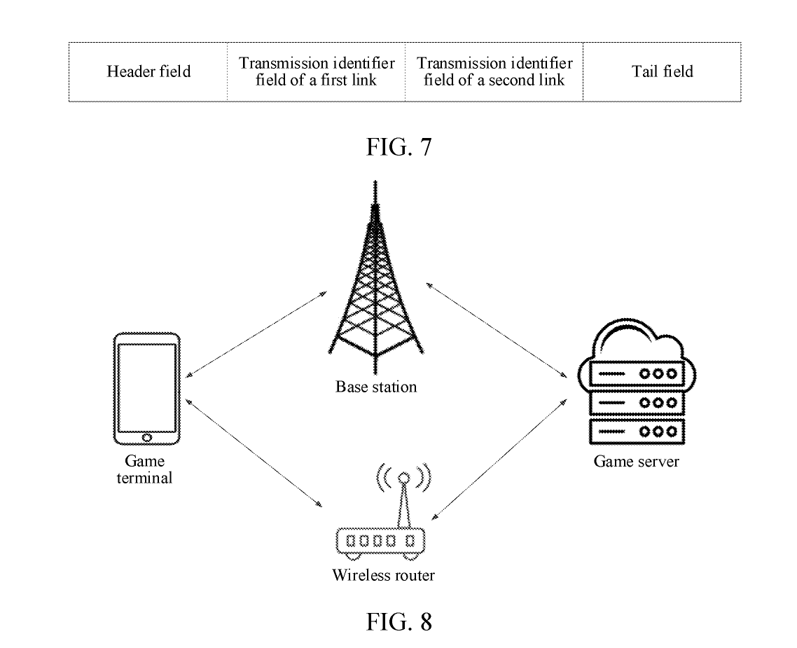

For ease of understanding, referring to FIG. 7, FIG. 7 is a schematic diagram of transmission indication information. As shown in FIG. 7, the transmission indication information includes a header field, a transmission identifier field of the first link, a transmission identifier field of the second link, and a tail field. Performing value filling on a specified field in the transmission indication information may be performing value filling on the transmission identifier field of the first link and the transmission identifier field of the second link.

As described in the foregoing embodiments, if the target transmission policy is the transmission through both the second link and the first link, in some embodiments of the present disclosure, a process of performing value filling on a specified field in the generated transmission indication information may include:
filling both the transmission identifier field of the second link and the transmission identifier field of the first link in the generated transmission indication information with an enabling value.

In other words, in some embodiments, when the target transmission policy is the transmission through both the second link and the first link, the transmission control party fills the transmission identifier of the second link and the transmission identifier of the first link in the generated transmission indication information with an enabling value.

For example, assuming that the target transmission policy is a transmission policy in which the 4G cellular network link and the wireless fidelity network link are used, the first link is the wireless fidelity network, and the second link is the 4G cellular network link, both a transmission identifier field of the 4G cellular network link and a transmission identifier field of the wireless fidelity network in the transmission indication information are filled with an enabling value (for example, the enabling value is represented by 1).

For another example, assuming that the target transmission policy is a transmission policy in which the 5G cellular network link and the wireless fidelity network link are used, the first link is the wireless fidelity network, and the second link is the 5G cellular network link, both a transmission identifier field of the 5G cellular network link and the transmission identifier field of the wireless fidelity network in the transmission indication information are filled with an enabling value (for example, the enabling value is represented by 1).

In this way, by implementing the foregoing embodiments, the transmission indication information can be obtained easily and accurately, so that strong support is provided for the data transmission party to switch service data from the first link to a target network link corresponding to the target transmission policy in the transmission indication information for transmission.

As described in the foregoing embodiments, if a target transmission policy is transmission through the second link, in some embodiments of the present disclosure, the process of performing value filling on a specified field in the generated transmission indication information may include:
filling the transmission identifier field of the second link in the generated transmission indication information with an enabling value, and filling the transmission identifier field of the first link in the generated transmission indication information with a disabling value.

In other words, in some embodiments, when the target transmission policy is the transmission through both the second link and the first link, the transmission control party fills the transmission identifier field of the second link in the generated transmission indication information with an enabling value and fills the transmission identifier field of the first link in the generated transmission indication information with a disabling value.

For example, assuming that the target transmission policy is a transmission policy in which the 4G cellular network link is used, the first link is the wireless fidelity network, and the second link is the 4G cellular network link. In this case, the transmission identifier field of the 4G cellular network link in the transmission indication information is filled with an enabling value (for example, the enabling value is represented by 1), and the transmission identifier fields of the wireless fidelity network in the transmission indication information are all filled with a disabling value (for example, the disable value is represented by 0).

For another example, assuming that the target transmission policy is the transmission policy in which the 5G cellular network link is used, the first link is the wireless fidelity network, and the second link is the 5G cellular network link. In this case, the transmission identifier field of the 5G cellular network link in the transmission indication information is filled with an enabling value (for example, the enable value is represented by 1), and the transmission identifier field of the wireless fidelity network in the transmission indication information is filled with a disabling value (for example, the disabling value is represented by 0).

In this way, by implementing the foregoing embodiments, the transmission indication information can be obtained easily and accurately, so that strong support is provided for the data transmission party to switch service data from the first link to a target network link corresponding to the target transmission policy in the transmission indication information for transmission.

S602: Receive service data transmitted by the data transmission party through a target link.

In this embodiment of the present disclosure, the data transmission party transmits the service data to the transmission control party through the target link, and correspondingly, the transmission control party receives the service data transmitted by the data transmission party through the target link.

For detailed descriptions of S201 and S202 shown in FIG. 6, reference may be made to S201 to S202 shown in FIG. 2, and details are not described herein again.

In this embodiment of the present disclosure, the transmission control party transmits the target transmission policy to the data transmission party, and correspondingly, the data transmission party switches the service data from the first link to the target network link corresponding to the target transmission policy for transmission, thereby improving the transmission efficiency of the service data.

The following describes a specific scenario in this embodiment of the present disclosure in detail.

Referring to FIG. 8, the system mainly includes a game terminal, a base station, a wireless router, and a game server. The game terminal may establish a cellular network link with the game server through the base station to transmit game data, and the game terminal may establish a wireless fidelity network link with the game server through the wireless router to transmit the game data.

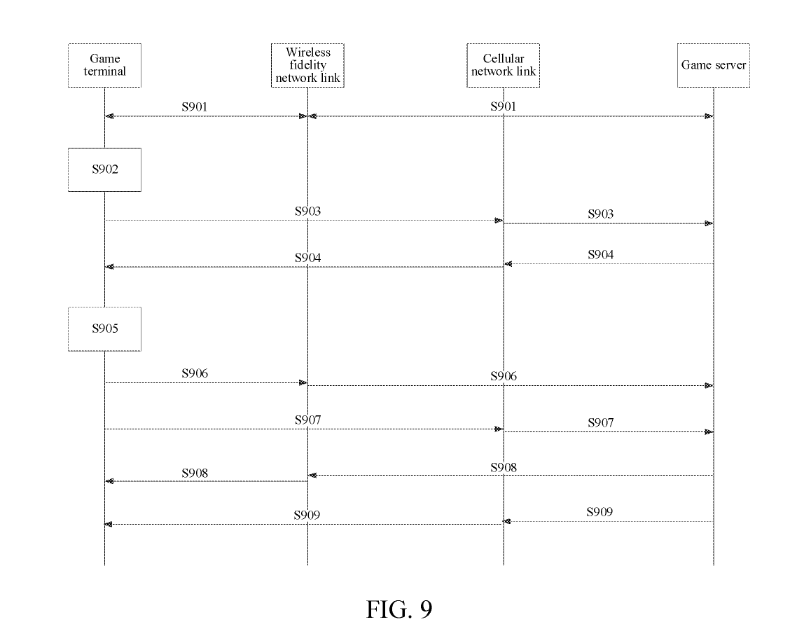

Based on the application environment in FIG. 8, referring to FIG. 9, FIG. 9 is a flowchart of a data transmission control method according to some embodiments of the present disclosure. As shown in FIG. 9, the data transmission control method at least includes S901 to S909, which are described in detail below.

S901: A game terminal transmits game data with a game server through a wireless fidelity network link.

S902: In a process of transmitting the game data with the game server through the wireless fidelity network link, when it is determined that network quality of the wireless fidelity network link is lower than a first preset quality threshold based on a network quality indicator value corresponding to the wireless fidelity network link, in response to determining that the network quality of the wireless fidelity network link is lower than a second preset quality threshold based on the network quality indicator value corresponding to the wireless fidelity network link, or it is determined that network quality of a cellular network link is greater than a third preset quality threshold based on a network quality indicator value corresponding to the cellular network link, the game terminal selects a transmission policy in which the cellular network link is used from the candidate transmission policies as a target transmission policy.

S903: The game terminal transmits transmission indication information (which may alternatively be referred to as switching information) corresponding to the transmission policy in which the cellular link to the game server through the cellular network link.

S904: The game server receives the transmission indication information transmitted by the game terminal through the cellular network link and transmits the game data to the game terminal through the cellular network link.

S905: In a process of transmitting the game data with the game server through the wireless fidelity network link, when it is determined that network quality of the wireless fidelity network link is lower than a first preset quality threshold based on a network quality indicator value corresponding to the wireless fidelity network link, in response to determining that network quality of a wireless fidelity network link is higher than a second preset quality threshold based on a network quality indicator value corresponding to the wireless fidelity network link, and it is determined that network quality of a cellular network link is lower than a third preset quality threshold based on the network quality indicator value corresponding to the wireless fidelity network link, the game terminal selects a transmission policy in which the cellular network link and the wireless fidelity network link are used from the candidate transmission policies as a target transmission policy.

S906: The game terminal transmits transmission indication information (or referred to as switching information) corresponding to a transmission policy in which both the cellular network link and the wireless fidelity network are used to the game server through the wireless fidelity network link.

S907: The game terminal transmits transmission indication information (which may alternatively be referred to as switching information) corresponding to the transmission policy in which both the cellular network link and the wireless fidelity network are used to the game server through the cellular network link.

S908. The game server receives the transmission indication information transmitted by the game terminal through the wireless fidelity network link, and transmits the game data to the game terminal through the wireless fidelity network link.

S909: The game server receives the transmission indication information transmitted by the game terminal through the cellular network link and transmits the game data to the game terminal through the cellular network link.

For detailed descriptions of S901 to S909 shown in FIG. 9, reference may be made to the foregoing embodiments, and details are not described herein again.

In the embodiments of the present disclosure, the network quality of the wireless fidelity network link and network quality of the cellular network link are detected in real time. When the network quality of the wireless fidelity network link is medium and the network quality of the cellular network link is poor, the game data is simultaneously transmitted through a double link of both the wireless fidelity network link and the cellular network link. When the network quality of the wireless fidelity network link is poor or the network quality of the cellular network link is superior, the service data is transmitted through the cellular network link. In this way, high real-time performance and high flexibility are achieved, and a network quality change is adapted, thereby greatly improving the game data transmission efficiency, and improving use experience of a game user.

An interaction process between the game terminal and the game server for the game data is described in detail in this embodiment shown in FIG. 9, and a process of switching a network transmission link is described in detail below.

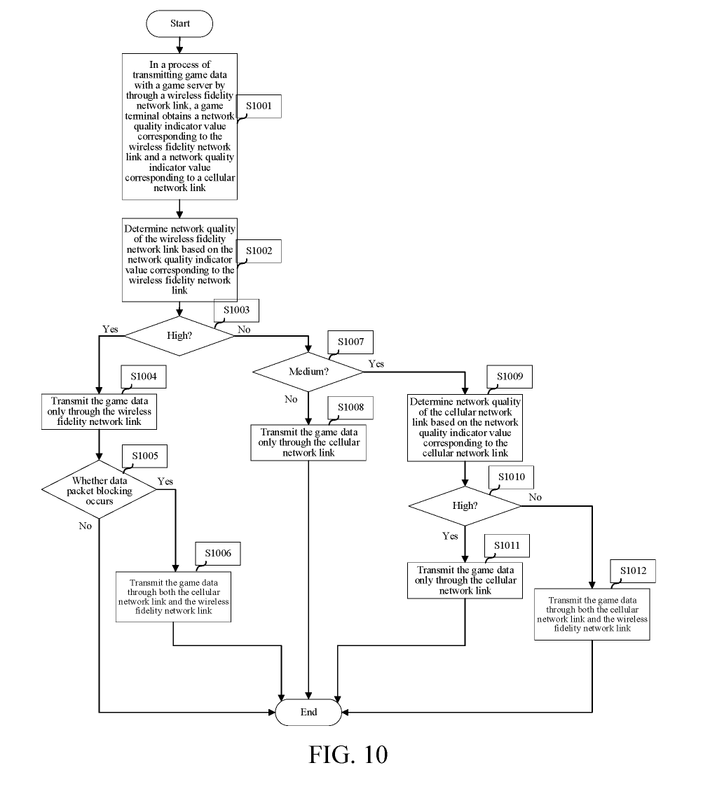

Referring to FIG. 10, FIG. 10 is a flowchart of a data transmission control method according to some embodiments of the present disclosure. As shown in FIG. 10, the data transmission control method at least includes S1001 to S1014, which are described in detail below.

S1001: In a process of transmitting game data with a game server by through a wireless fidelity network link, a game terminal obtains a network quality indicator value corresponding to the wireless fidelity network link and a network quality indicator value corresponding to a cellular network link.

S1002: Determine network quality of the wireless fidelity network link based on the network quality indicator value corresponding to the wireless fidelity network link.

S1003: Determine whether the wireless fidelity network link is superior (or whether the wireless fidelity network link is high).

S1004: Transmit the game data only through the wireless fidelity network link in response to determining that the network quality of the wireless fidelity network link is superior (or the network quality of the wireless fidelity network link is high).

S1005: Detect whether data packet blocking occurs on the wireless fidelity network link.

S1006: Transmit the game data through the cellular network link and the wireless fidelity network link at the same time in response to detecting that the data packet blocking occurs on the wireless fidelity network link.

Before the game data is transmitted through the cellular network link and the wireless fidelity network link, transmission indication information may be transmitted to the game server. Both a transmission identifier field of the cellular network link and a transmission identifier field of the wireless fidelity network link in the transmission indication information are filled with enabling values, to instruct the game server to simultaneously transmit the game data through the cellular network link and the wireless fidelity network link.

In response to detecting that no data packet blocking occurs on the wireless fidelity network link, the process is ended, and the game data is transmitted through the cellular network link and the wireless fidelity network link at the same time, and the process may be ended.

S1007: Determine whether the network quality of the wireless fidelity network link is medium (namely, intermediate) in response to determining that the network quality of the wireless fidelity network link is not superior (or the network quality of the wireless fidelity network link is not high).

S1008: Transmit the game data only through the cellular network link in response to determining that the network quality of the wireless fidelity network link is not medium.

The process may be ended if the game data is transmitted only through the cellular network link.

S1009: Detect the network quality of the cellular network link based on the network quality indicator value corresponding to the cellular network link in response to determining that the network quality of the cellular network link is medium.

S1010: Determine whether the network quality of the cellular network link is superior (or whether the network quality of the cellular network link is high).

S1011: Transmit the game data only through the cellular network link in response to determining that the network quality of the cellular network link is good (or the network quality of the cellular network link is high).

The process may be ended if the game data is transmitted only through the cellular network link.

S1012: Transmit the game data through the cellular network link and the wireless fidelity network link at the same time in response to determining that the network quality of the cellular network link is not superior (or the network quality of the cellular network link is not high).

The process may be ended when the game data is transmitted through the cellular network link and the wireless fidelity network link at the same time.

In this embodiment of the present disclosure, the network quality of the wireless fidelity network link and the network quality of the cellular network link are classified into three cases, namely, high, medium, and low, so that switching fine granularity of the network transmission link is higher.

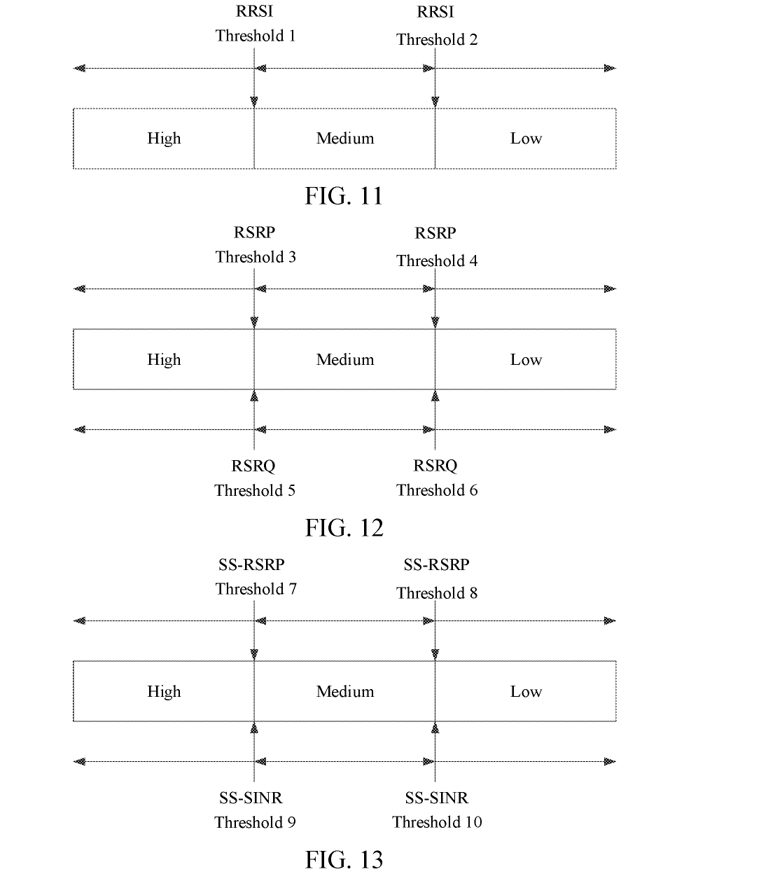

For ease of understanding, referring to FIG. 11, FIG. 11 is a schematic diagram of a threshold corresponding to a network quality indicator of a wireless fidelity network link. Network quality of the wireless fidelity network link may be classified into three cases, namely, high, medium, and low according to a threshold corresponding to each network indicator. An example in which the network quality indicator corresponding to the wireless fidelity network link is an RRSI is used. As shown in FIG. 11, a Threshold 1 and a Threshold 2 are thresholds corresponding to the RRSI (namely, the preset thresholds in the foregoing embodiments, which are the same below). When a value of the RRSI obtained in real time is greater than the Threshold1, the network quality of the wireless fidelity network link may be classified into a high level (that is, the network quality is superior). When the value of the RRSI obtained in real time is less than or equal to the Threshold1 and greater than the Threshold2, the network quality of the wireless fidelity network link may be classified into a medium level (that is, the network quality is medium). When the RRSI value obtained in real time is less than or equal to the Threshold2, the network quality of the wireless fidelity network link may be classified into a low level (that is, the network quality is poor).

For ease of understanding, referring to FIG. 12, FIG. 12 is a schematic diagram of a threshold corresponding to a network quality indicator of a 4G cellular network link. Network quality of the 4G cellular network link may be classified into three cases, namely, high, medium, and low according to a threshold corresponding to each network indicator. An example in which the network quality indicator corresponding to the 4G cellular network link is an RSRP and an RSRQ are used. As shown in FIG. 12, a Threshold 3 and a Threshold 4 are thresholds corresponding to the RSRP, and a Threshold 5 and a Threshold 6 are thresholds corresponding to the RSRQ. The network quality of the 4G cellular network link may be classified into three cases, namely, high, medium, and low through the following operations.
(a1) When an value of the RSRP obtained in real time is greater than the Threshold3 and an value of the RSRQ obtained in real time is greater than the Threshold5, the network quality of the 4G cellular network link may be classified into a high level.
(a2) When the value of the RSRP obtained in real time is less than the Threshold4 and the value of the RSRQ obtained in real time is less than the Threshold6, the network quality of the 4G cellular network link may be classified into a low level.
(a3) If neither of the foregoing cases a1) nor a2) applies, the network quality of the 4G cellular network link may be classified into a medium level.

For ease of understanding, referring to FIG. 13, FIG. 13 is a schematic diagram of a threshold corresponding to a network quality indicator of a 5G cellular network link. Network quality of the 5G cellular network link may be classified into three cases, namely, high, medium, and low according to a threshold corresponding to each network indicator. An example in which the network quality indicator corresponding to the 5G cellular network link is an SS-RSRP and an SS-SINR are used. As shown in FIG. 13, a Threshold 7 and a Threshold 8 are thresholds corresponding to the SS-RSRP, and a Threshold 9 and a Threshold 10 are thresholds corresponding to the SS-SINR. The network quality of the 5G cellular network link may be classified into three cases, namely, high, medium, and low through the following operations.
(b1) When an value of the SS-RSRP obtained in real time is greater than the Threshold7 and an value of the SS-SINR obtained in real time is greater than the Threshold9, the network quality of the 5G cellular network link may be classified into a high level.
(b2) When the value of the SS-RSRP obtained in real time is less than the Threshold8 and the value of the SS-SINR obtained in real time is less than the Threshold10, the network quality of the 5G cellular network link may be classified into a low level.
(b3) If neither of the foregoing cases b1) nor b2) applies, the network quality of the 5G cellular network link may be classified into a medium level.

In another embodiment, network quality of a transmission network link (for example, a wireless fidelity network link or a cellular network link) may further be subdivided into more cases, for example, high, relatively high, medium, relatively low, and low. In actual application, level division of the network quality may be flexibly adjusted according to a specific application scenario.

In this embodiment of the present disclosure, the network quality of the transmission network link (for example, the wireless fidelity network link or the cellular network link) can be easily and accurately determined through the network quality indicator value of the transmission network link, so that switching efficiency and switching accuracy of the transmission network link are improved. This is applicable to a plurality of scenarios, and in particular, to an performing scenario of a low-delay-required service.

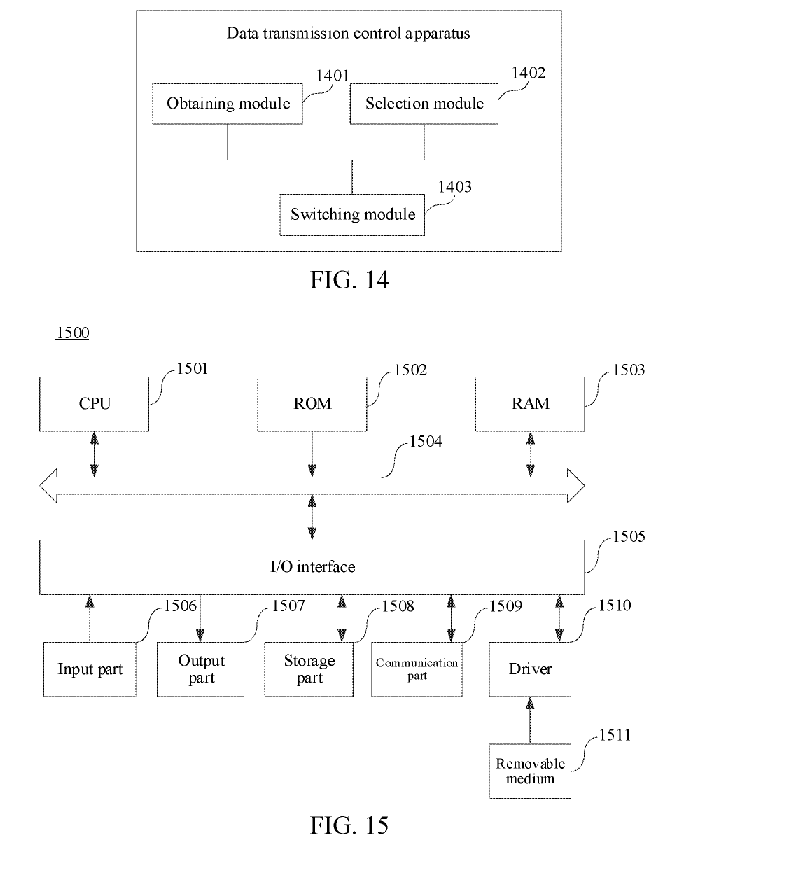

FIG. 14 is a block diagram of a data transmission control apparatus according some embodiments of the present disclosure. As shown in FIG. 14, the apparatus is configured in a terminal device, and the terminal device respectively establishes a first link and a second link to a server through a first-type network and a second-type network. The apparatus includes:
an obtaining module 1401, configured to obtain, in a process of transmitting service data through the first link, a network quality indicator value corresponding to the first link;
a selection module 1402, configured to, in response to determining, based on the obtained network quality indicator value corresponding to the first link, that network quality of the first link is lower than a first preset quality threshold, select, from candidate transmission policies based on the network quality indicator value corresponding to the first link and a network quality indicator value corresponding to the second link, a target transmission policy configured to transmit the service data, the candidate transmission policies including transmission through the second link, and transmission through both the second link and the first link; and
a switching module 1403, configured to switch the service data from the first link to a target network link corresponding to the target transmission policy for transmission.

The apparatus provided in the foregoing embodiment and the method provided in the foregoing embodiments belong to the same idea. Specific operation manners of the modules and the units are described in detail in the method embodiments.

The embodiments of the present disclosure further provide an electronic device, including: at least one processor; and a memory, configured to store at least one program, the electronic device, when the at least one program is executed by the at least one processor, being caused to implement the foregoing data transmission control method.

FIG. 15 is a schematic structural diagram of a computer system adapted to implement an electronic device according to an embodiment of the present disclosure.

The computer system 1500 of the electronic device shown in FIG. 15 is merely an example, and does not constitute any limitation on functions and use ranges of the embodiments of the present disclosure.

As shown in FIG. 15, the computer system 1500 includes a central processing unit (CPU) 1501, which may perform various suitable actions and processing according to a program stored in a read-only memory (ROM) 1502 or a program loaded from a storage part 1508 into a random access memory (RAM) 1503, for example, perform the method in the foregoing embodiments. The RAM 1503 further stores various programs and data required for system operations. The CPU 1501, the ROM 1502, and the RAM 1503 are connected to each other through a bus 1504. An input/output (I/O) interface 1505 is also connected to the bus 1504.

The following components are connected to an I/O interface 1505, including an input part 1506 including a keyboard, a mouse, and the like; an output part 1507, including a cathode ray tube (CRT), a liquid crystal display (LCD), a speaker, and the like; a storage part 1508, including a hard disk and the like; and a communication part 1509, including a network interface card such as a local area network (LAN) card, a modem, and the like. The communication part 1509 performs communication processing by using a network such as the Internet. A driver 1510 is also connected to the I/O interface 1505 as required. A removable medium 1511, such as a magnetic disk, an optical disc, a magneto-optical disk, or a semiconductor memory, is mounted on the driver 1510 as required, so that a computer program read from the removable medium 1511 is installed into the storage part 1508 as required.

Specially, according to the embodiments of the present disclosure, the process described in the foregoing with reference to the flowchart may be implemented as a computer software program. For example, the embodiments of the present disclosure includes a computer program product, the computer program product including a computer program carried on a computer-readable medium. The computer program includes a computer program configured for performing the method shown in the flowchart. In such an embodiment, the computer program may be downloaded and installed from a network through the communication part 1509, and/or installed from the removable medium 1511. When the computer program is executed by the central processing unit (CPU) 1501, various functions defined in the system of the present disclosure are executed.

The computer-readable medium shown in the embodiments of the present disclosure may be a computer-readable signal medium or a computer-readable storage medium or any combination thereof. The computer-readable medium may be such as electricity, magnetism, light, electromagnetism, infrared light, or a semiconductor system, apparatus, or device, or any combination thereof. A more specific example of the computer-readable medium may include but is not limited to: an electrical connection having at least one wire, a portable computer magnetic disk, a hard disk, a random access memory (RAM), a read-only memory (ROM), an erasable programmable read only memory (EPROM), a flash memory, an optical fiber, a compact disc read-only memory (CD-ROM), an optical storage device, a magnetic storage device, or any appropriate combination thereof. In the present disclosure, the computer-readable medium may be any tangible medium including or storing a program, and the program may be used by or used in combination with an instruction execution system, apparatus, or device. In the present disclosure, a computer-readable signal medium may include a data signal transmitted in a baseband or as a part of a carrier, and has a computer-readable computer program stored therein. The propagated data signal may be in a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, apparatus, or device. The computer program included in the computer-readable medium may be transmitted by using any suitable medium, including but not limited to: a wireless medium, a wire, or the like, or any suitable combination thereof.

The flowcharts and block diagrams in the accompanying drawings illustrate system architectures, functions, and operations that may be implemented for the system, the method, and the computer program product according to the embodiments of the present disclosure. Each box in the flowcharts or the block diagrams may represent a module, a program segment, or a part of code. The module, the program segment, or the part of code includes at least one executable instruction configured for implementing a specified logic function. In some implementations used as substitutes, functions annotated in boxes may alternatively occur in a sequence different from a sequence annotated in an accompanying drawing. For example, two boxes shown in succession may actually be performed basically in parallel, and sometimes the two boxes may be performed in a reverse sequence. This is determined by a related function. Each block in the block diagram or the flowchart, and a combination of blocks in the block diagram or the flowchart may be implemented by using a dedicated hardware-based system that performs a specified function or operation, or may be implemented by using a combination of dedicated hardware and computer instructions.

Related units described in the embodiments of the present disclosure may be implemented in a software manner, or may be implemented in a hardware manner, and the unit described may alternatively be set in a processor. Names of these units do not constitute a limitation on the units in a case.

The embodiments of the present disclosure further provide a computer-readable medium, having a computer program stored therein, the computer program, when being executed by a processor, implements the foregoing data transmission control method. The computer-readable medium may be included in the electronic device described in the foregoing embodiments, or may exist alone, and is not assembled in the electronic device.

The embodiments of the present disclosure further provide a computer program product or a computer program. The computer program product or the computer program includes computer instructions, and the computer instructions are stored in a computer-readable medium. A processor of a computer device reads the computer instructions from the computer-readable medium, and executes the computer instructions, so that the computer device performs the data transmission control method provided in the foregoing embodiments.

The foregoing descriptions are merely preferable exemplary embodiments of the present disclosure, and are not intended to limit the embodiments of the present disclosure. A person of ordinary skill in the art can make corresponding modifications and variations with ease without departing from the spirit and scope of the embodiments of the present disclosure. Therefore, the protection scope of the present disclosure shall be subject to the protection scope of the claims.

What is claimed is:

1. A data transmission control method, performed by a terminal device, the terminal device having established a first link and a second link with a server respectively through a first-type network and a second-type network, and the method comprising:
obtaining a network quality indicator value corresponding to the first link in a process of transmitting service data through the first link;
in response to determining, based on the network quality indicator value corresponding to the first link, that network quality of the first link is lower than a first preset quality threshold, selecting, from candidate transmission policies based on the network quality indicator value corresponding to the first link and a network quality indicator value corresponding to the second link, a target transmission policy configured to transmit the service data, the candidate transmission policies comprising a policy of transmission through the second link, and a policy of transmission through both the second link and the first link; and
switching from the first link to a target network link corresponding to the target transmission policy and transmitting the service data through the target network link.

2. The method according to claim 1, wherein the selecting, from candidate transmission policies based on the network quality indicator value corresponding to the first link and a network quality indicator value corresponding to the second link, a target transmission policy configured to transmit the service data comprises:
selecting, from the candidate transmission policies, the transmission through both the second link and the first link as the target transmission policy in response to determining, based on the network quality indicator value of the first link, that the network quality of the first link is higher than a second preset quality threshold, and determining, based on the network quality indicator value corresponding to the second link, that network quality of the second link is lower than a third preset quality threshold; and
the switching from the first link to a target network link corresponding to the target transmission policy and transmitting the service data through the target network link comprises:
transmitting the same service data through the first link and the second link.

3. The method according to claim 1, wherein the selecting, from candidate transmission policies based on the network quality indicator value corresponding to the first link and a network quality indicator value corresponding to the second link, a target transmission policy configured to transmit the service data comprises:
selecting, from the candidate transmission policies, the transmission through the second link as the target transmission policy in response to determining, based on the network quality indicator value of the first link, that the network quality of the first link is lower than a second preset quality threshold, or determining, based on the network quality indicator value corresponding to the second link, that network quality of the second link is higher than a third preset quality threshold; and
the switching from the first link to a target network link corresponding to the target transmission policy and transmitting the service data through the target network link comprises:
switching from the first link to the second link, and transmitting the service data through the switched second link.

4. The method according to claim 1, further comprising:
obtaining a service request for the service data; and
transmitting service data corresponding to the service request through the first link in response to detecting that a service requirement delay targeted by the service request is less than a preset delay threshold.

5. The method according to claim 4, wherein the transmitting service data corresponding to the service request through the first link comprises:
obtaining the network quality indicator value corresponding to the first link; and
transmitting the service data corresponding to the service request through the first link in response to determining, based on the network quality indicator value corresponding to the first link, that the network quality of the first link is higher than the first preset quality threshold.

6. The method according to claim 1, wherein the switching from the first link to a target network link corresponding to the target transmission policy and transmitting the service data through the target network link comprises:
transmitting the target transmission policy to the server, to cause the server to switch from the first link to the target network link corresponding to the target transmission policy for transmitting the service data; and
receiving the service data transmitted by the server through the target network link.

7. The method according to claim 6, wherein the transmitting the target transmission policy to the server comprises:
transmitting the target transmission policy to the server through the second link and the first link separately in response to the target transmission policy being the transmission through both the second link and the first link; and
transmitting the target transmission policy to the server through the second link in response to the target transmission policy being the transmission through the second link.

8. The method according to claim 7, wherein the transmitting the target transmission policy to the server through the second link and the first link separately comprises:
generating transmission indication information corresponding to the target transmission policy, filling a transmission identifier field of the second link and a transmission identifier field of the first link in the generated transmission indication information with an enabling value, and transmitting the filled transmission indication information to the server through the second link and the first link respectively; and
the transmitting the target transmission policy to the server through the second link comprises:
generating the transmission indication information corresponding to the target transmission policy, filling the transmission identifier field of the second link in the generated transmission indication information with an enabling value, filling the transmission identifier field of the first link in the generated transmission indication information with a disabling value, and transmitting the filled transmission indication information to the server through the second link.

9. The method according to claim 1, further comprising:
detecting a magnitude relationship between the network quality indicator value corresponding to the first link and a first preset threshold, to obtain a first detection result; and
determining that the network quality of the first link is higher than the first preset quality threshold in response to the first detection result indicating that the network quality indicator value corresponding to the first link is greater than the first preset threshold; or
determining that the network quality of the first link is lower than the first preset quality threshold in response to the first detection result indicating that the network quality indicator value corresponding to the first link is less than or equal to the first preset threshold.

10. The method according to claim 1, further comprising:
detecting a magnitude relationship between the network quality indicator value corresponding to the first link and a second preset threshold, to obtain a second detection result; and
determining that the network quality of the first link is higher than the second preset quality threshold in response to the second detection result indicating that the network quality indicator value corresponding to the first link is greater than the second preset threshold; or
determining that the network quality of the first link is lower than the second preset quality threshold in response to the second detection result indicating that the network quality indicator value corresponding to the first link is less than or equal to the second preset threshold.

11. The method according to claim 1, further comprising:
detecting a relationship between the network quality indicator value corresponding to the second link and a third preset threshold, to obtain a third detection result; and
determining that the network quality of the second link is higher than the third preset quality threshold in response to the third detection result indicating that the network quality indicator value corresponding to the second link is greater than the third preset threshold; or
determining that the network quality of the second link is lower than the third preset quality threshold in response to the third detection result indicating that the network quality indicator value corresponding to the second link is less than or equal to the third preset threshold.

12. The method according to claim 1, further comprising :
keeping transmitting the service data through the first link in response to determining that the network quality of the first link is higher than the first preset quality threshold based on the network quality indicator value corresponding to the first link.

13. The method according to claim 12, further comprising :
detecting, in a process of transmitting the service data through the first link, whether data packet congestion occurs on the first link, and transmitting the service data through both the first link and the second link when the data packet congestion occurs on the first link.

14. The method according to claim 1, further comprising :
the first-type network is a wireless fidelity network, and the second-type network is a cellular network; or
the first-type network is a cellular network, and the second-type network is a wireless fidelity network.

15. An electronic device, comprising:
at least one processor; and
a memory, configured to store at least one program, the electronic device, when the at least one program is executed by the electronic device, the at least one processor is configured to perform:
obtaining a network quality indicator value corresponding to the first link in a process of transmitting service data through the first link, wherein the electronic device has established the first link and a second link with a server respectively through a first-type network and a second-type network;
in response to determining, based on the network quality indicator value corresponding to the first link, that network quality of the first link is lower than a first preset quality threshold, selecting, from candidate transmission policies based on the network quality indicator value corresponding to the first link and a network quality indicator value corresponding to the second link, a target transmission policy configured to transmit the service data, the candidate transmission policies comprising a policy of transmission through the second link, and a policy of transmission through both the second link and the first link; and
switching from the first link to a target network link corresponding to the target transmission policy and transmitting the service data through the target network link.

16. The electronic device according to claim 15, wherein the selecting, from candidate transmission policies based on the network quality indicator value corresponding to the first link and a network quality indicator value corresponding to the second link, a target transmission policy configured to transmit the service data comprises:
selecting, from the candidate transmission policies, the transmission through both the second link and the first link as the target transmission policy in response to determining, based on the network quality indicator value of the first link, that the network quality of the first link is higher than a second preset quality threshold, and determining, based on the network quality indicator value corresponding to the second link, that network quality of the second link is lower than a third preset quality threshold; and
the switching from the first link to a target network link corresponding to the target transmission policy and transmitting the service data through the target network link comprises:
transmitting the same service data through the first link and the second link.

17. The electronic device according to claim 15, wherein the selecting, from candidate transmission policies based on the network quality indicator value corresponding to the first link and a network quality indicator value corresponding to the second link, a target transmission policy configured to transmit the service data comprises:
selecting, from the candidate transmission policies, the transmission through the second link as the target transmission policy in response to determining, based on the network quality indicator value of the first link, that the network quality of the first link is lower than a second preset quality threshold, or determining, based on the network quality indicator value corresponding to the second link, that network quality of the second link is higher than a third preset quality threshold; and
the switching from the first link to a target network link corresponding to the target transmission policy and transmitting the service data through the target network link comprises:
switching from the first link to the second link, and transmitting the service data through the switched second link.

18. The electronic device according to claim 15, wherein the switching from the first link to a target network link corresponding to the target transmission policy and transmitting the service data through the target network link comprises:
transmitting the target transmission policy to the server, to cause the server to switch from the first link to the target network link corresponding to the target transmission policy for transmitting the service data; and
receiving the service data transmitted by the server through the target network link.

19. The electronic device according to claim 18, wherein the transmitting the target transmission policy to the server comprises:
transmitting the target transmission policy to the server through the second link and the first link separately in response to the target transmission policy being the transmission through both the second link and the first link; and
transmitting the target transmission policy to the server through the second link in response to the target transmission policy being the transmission through the second link.

20. A non-transitory computer-readable medium, having a computer program stored therein, the computer program, when being executed by a processor of a terminal device, causing the processor to implement:
obtaining a network quality indicator value corresponding to a first link in a process of transmitting service data through the first link, wherein the terminal device has established the first link and a second link with a server respectively through a first-type network and a second-type network;
in response to determining, based on the network quality indicator value corresponding to the first link, that network quality of the first link is lower than a first preset quality threshold, selecting, from candidate transmission policies based on the network quality indicator value corresponding to the first link and a network quality indicator value corresponding to the second link, a target transmission policy configured to transmit the service data, the candidate transmission policies comprising a policy of transmission through the second link, and a policy of transmission through both the second link and the first link; and
switching from the first link to a target network link corresponding to the target
transmission policy and transmitting the service data through the target network link.
